(19) United States
(12) Patent Application Publication
(10) Pub. No.: US 2022/0018345 A1
(43) Pub. Date: Jan. 20, 2022

(54) SCREW SPINDLE PUMP

(71) Applicant: NIDEC GPM GmbH, Auengrund OT Merbelsrod (DE)

(72) Inventors: Conrad NICKEL, Troistedt (DE); Franz PAWELLEK, Lautertal (DE)

(21) Appl. No.: 17/294,712

(22) PCT Filed: Nov. 29, 2019
(86) PCT No.: PCT/EP2019/083092

§ 371 Date: May 18, 2021

(30) Foreign Application Priority Data
Nov. 30, 2018 (DE) 10 2018 130 472.2

(51) Int. Cl. F04C 2/16; F04C 15/00; H01M 10/625

(52) U.S. Cl. CPC F04C 2/16; F04C 15/0038; F04C 2240/60; H01M 10/625; F04C 2240/40; F04C 15/008

(57) ABSTRACT

An electric coolant pump to cool battery packs of a battery-powered motor vehicle includes an electric motor with a shaft. The electric coolant pump includes a screw spindle pump with a drive spindle and at least one secondary spindle. The drive spindle is connected to the shaft of the electric motor in a rotationally fixed manner.

### CROSS REFERENCE TO RELATED APPLICATIONS

This is a U.S. national stage of PCT Application No. PCT/EP2019/083092, filed on Nov. 29, 2019, with priority under 35 U.S.C. § 119(a) and 35 U.S.C. § 365(b) being claimed from German Application No. 102018130472.2, filed Nov. 30, 2018, the entire disclosures of which are hereby incorporated herein by reference.

### 1. FIELD OF THE INVENTION

The present invention relates to an electric coolant pump.

### 2. BACKGROUND

Electric coolant pumps are used for battery cooling in battery-powered motor vehicles. A large number of battery cells are combined in a battery pack. The battery packs of the motor vehicle drive are cooled to increase efficiency. Glandless pumps with cans are known to be used in such cooling systems, where the electromagnetic flux between the stator and magnetic poles of a rotor of a permanently excited motor is weakened. In addition, these pumps cause considerable splash losses of the rotating rotor in the cooling medium. Conventionally, such pumps for battery cooling are designed with radial impellers. Due to an unfavorable ratio of volume flow and pressure increase, this results in a rather poor hydraulic-mechanical efficiency. However, especially when cooling battery packs of an electric car, it is important to achieve a high efficiency in order to increase the range of the battery-powered motor vehicle.

### SUMMARY

Example embodiments of the present disclosure provide electric coolant pumps that each cool battery packs of battery-powered motor vehicles with high efficiency.

An electric coolant pump to cool battery packs of a battery-powered motor vehicle according to an example embodiment of the present disclosure includes an electric motor with a shaft. The electric coolant pump includes a screw spindle pump with a drive spindle and at least one secondary spindle. The drive spindle is non-rotatably connected to the shaft of the electric motor.

The electrically driven screw spindle pump has a very good efficiency and thus increases the cooling efficiency and indirectly the range of the battery-powered motor vehicle. In general, the battery-powered motor vehicle can be a purely electric vehicle or a hybrid vehicle.

Preferably, the electric motor is a dry-running motor, which can further increase efficiency.

In an example embodiment, the electric motor is in a motor housing and the screw spindle pump is in a pump housing. The motor housing is connected to the pump housing, and the shaft of the electric motor is sealed by a seal which prevents liquid penetrating from the pump housing. The pump housing is preferably connected to the motor housing through a flange.

The shaft of the electric motor is preferably sealed in the motor housing with a sealing washer and a main seal. The sealing washer is located in front of the main seal, starting from the drive spindle. The main seal preferably is a double lip seal. A space is provided between the sealing disc and the main seal, which is relieved of pressure via a connecting bore to the intake area. In this way, the main seal is only subjected to a low intake pressure and not to the higher delivery pressure. A leakage chamber is preferably provided behind the main seal. This is bounded by an additional seal to protect the bearing provided to support the shaft. Preferably, the bearing is a compact bearing in which the seal is already integrated.

In an advantageous example embodiment, a single secondary spindle is provided.

The electric motor is advantageously an internal rotor motor including a rotor and a stator, the stator preferably including electromagnets and the rotor preferably including permanent magnets.

Furthermore, a battery pack of a battery-powered motor vehicle is provided with at least one cooling device to cool the battery pack, which includes an electric coolant pump described above.

Such a battery pack is preferably used in battery-powered motor vehicles.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a spatial view of an electric coolant pump.

FIG. 2 is a top view of the electric coolant pump in FIG. 1.

FIG. 3 is a longitudinal section through the electric coolant pump of FIG. 2 along line A-A.

FIG. 4 is a longitudinal section through the electric coolant pump of FIG. 2 along line B-B.

FIG. 5 is a longitudinal section through the electric coolant pump of FIG. 2 along line C-C.

### DETAILED DESCRIPTION

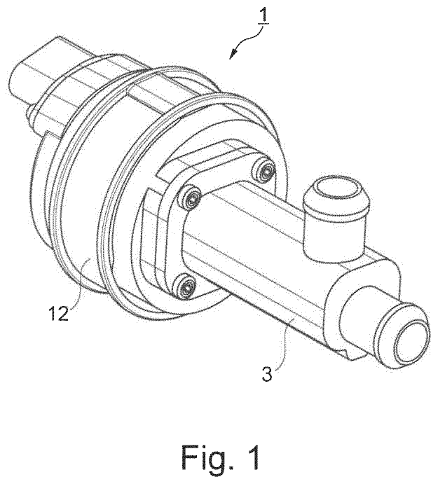

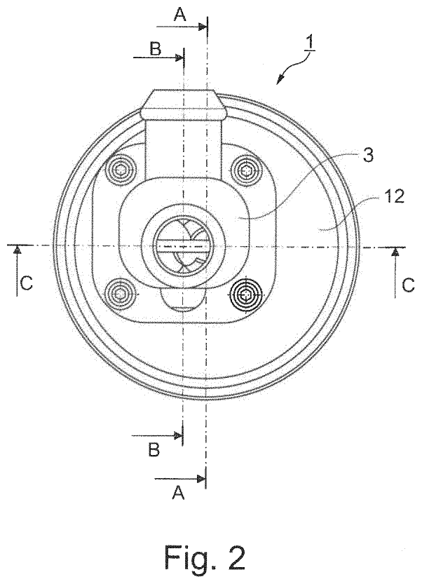

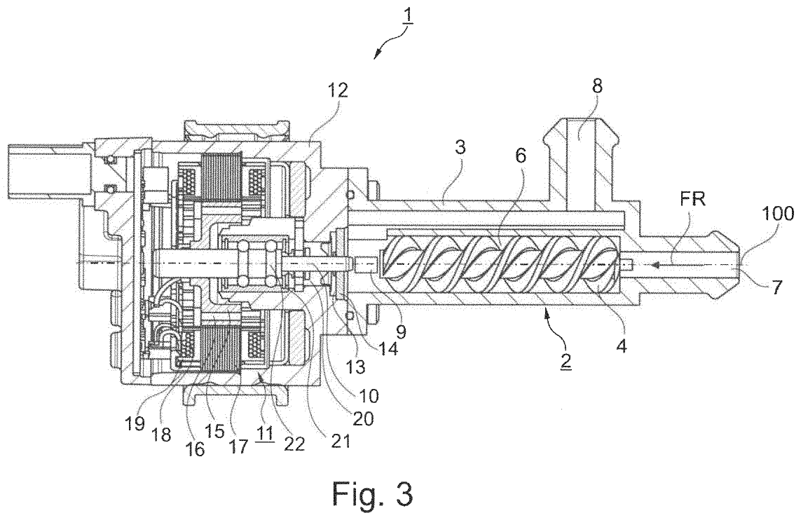

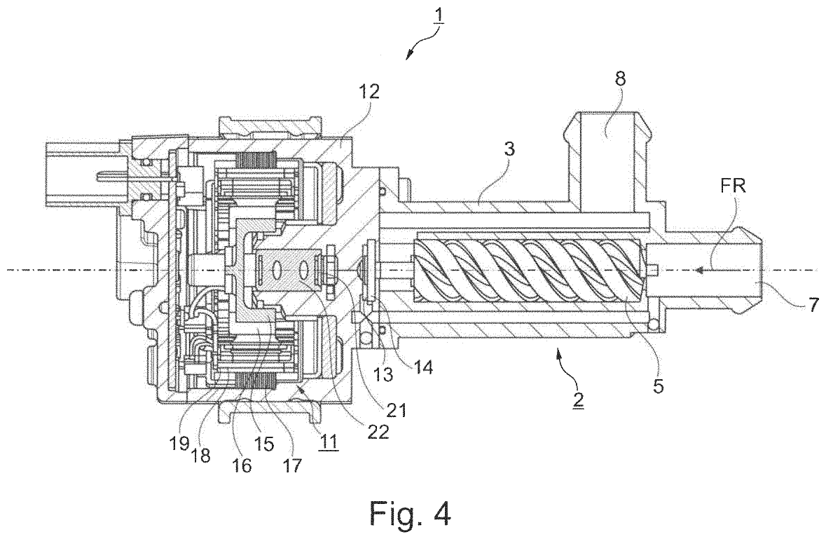

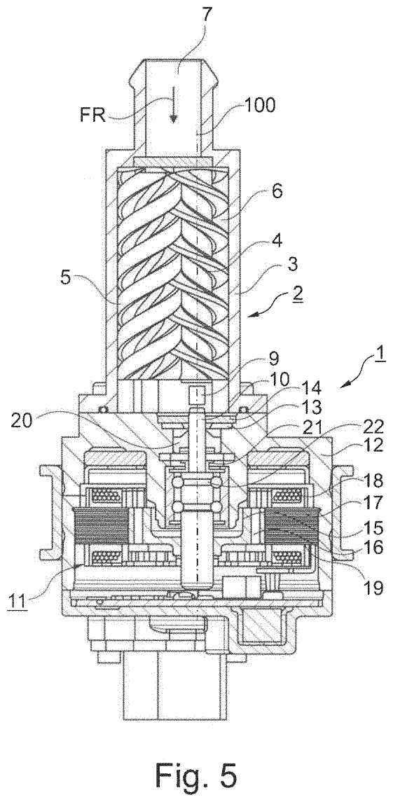

FIGS. 1 to 5 show an electric coolant pump 1 formed as a screw spindle pump 2. The screw spindle pump 2 is surrounded by a pump housing 3. A drive spindle 4 and a secondary spindle 5 are arranged in the pump housing 3. The screw spindle pump 2 is a so-called positive displacement pump, in which the shape of the rotating displacer resembles that of a spindle screw. The drive spindle 4 and the secondary spindle 5 are formed with a regular, thread-like profiling and mesh with each other in a gear-like manner.

The cavities 6, which are formed by the pump housing 3, the drive spindle 4 and the secondary spindle 5, form the delivery spaces for the pumped medium, preferably coolant fluid. The pumped medium flows in flow direction SR1 through an intake channel 7 into the pump housing 3 and is transported through the pump housing in pumping direction FR parallel to the axis of rotation or longitudinal axis 100 of the drive spindle 4. When the screw spindles 4,5 rotate, the delivery chambers move in the delivery direction FR and thus convey the medium from the suction side (=intake channel) to the discharge side (=outlet channel). The medium leaves the pump housing 2 via the outlet channel 8, which is aligned radially outwards to the longitudinal axis of the drive spindle 100.

The drive spindle 4 is hydraulically mounted in the pump housing 3. The drive spindle 4 is coupled to a shaft 10 of an electric motor 11 by means of a coupling 9. The electric motor 11 is a dry rotor motor. The electric motor 11 is surrounded by a motor housing 12 which is firmly connected to the pump housing. The shaft 10 of the electric motor is sealed in the motor housing 12 by a sealing washer 14 and a main seal 13. Starting from the drive spindle 4, the sealing disc 14 is located in front of the main seal 13. The main seal 13 preferably comprises a double lip seal. A space is formed between the sealing disc 14 and the main seal 13, which is relieved of pressure via a connecting bore to the intake area. In this way, the main seal 13 is only subjected to a low intake pressure and not to the higher delivery pressure. A leakage chamber 20 is provided behind the main seal 13. This is bounded by a further seal 21, which is arranged to protect the bearing 22 provided to support the shaft. Preferably, the bearing 22 is a compact bearing in which the seal 21 is already integrated.

The drive spindle 4 is driven by the electric motor 11 for rotation about the longitudinal axis 100. The electric motor 11 has a rotor 15 non-rotatably connected to the shaft 10, and a stator 19 surrounding the rotor 15. The rotor 15 includes a rotor core and permanent magnets 16 disposed therearound. The stator 19 includes a number of electromagnets generally formed by an iron core 17 and a winding 18. Appropriate energization of the windings of the stator 18 generates a rotating field, which correspondingly generates a torque in the rotor 15 and thus drives the drive spindle 4 by means of the shaft 10.

The electric coolant pump 1 has very high efficiency and acoustic advantages due to pulsation-free delivery of the pumped medium and the preferred use of a high-pole electric motor with lower torque ripples for electrically powered motor vehicles. Because the electric motor rotates only in air, the viscous fluid friction of a wet rotor is eliminated and the air gap between the stator and rotor can be reduced. The screw spindle pump has a very good efficiency of 85-90%, resulting in a very high overall efficiency. Since less energy is required in cooling the battery packs, the load on the vehicle's electrical system can be reduced and the range of the motor vehicle can be extended during electric operation.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-11. (canceled)

12: An electric coolant pump to cool battery packs of a battery-powered motor vehicle, the electric coolant pump comprising:
an electric motor with a shaft; and
a screw spindle pump with a drive spindle and at least one secondary spindle; wherein
the drive spindle is non-rotatably connected to the shaft of the electric motor.

13: The electric coolant pump according to claim 12, wherein the electric motor is a dry rotor motor.

14: The electric coolant pump according to claim 12, wherein
the electric motor is in a motor housing;
the screw spindle pump is in a pump housing;
the motor housing is connected to the pump housing; and
the shaft of the electric motor is sealed by a seal against liquid penetrating from the pump housing.

15: The electric coolant pump according to claim 14, wherein the seal includes a lip seal and a sealing washer.

16: The electric coolant pump according to claim 14, wherein the seal is in the motor housing.

17: The electric coolant pump according to claim 12, further comprising a single secondary spindle.

18: The electric coolant pump according to claim 12, wherein the electric motor is an internal rotor motor and includes a rotor and a stator.

19: The electric coolant pump according to claim 18, wherein the stator includes electromagnets and the rotor includes permanent magnets.

20: A battery pack of a battery-operated motor vehicle comprising at least one cooling device to cool the battery pack, the cooling device including the electric coolant pump according to claim 12.

21: A battery-powered motor vehicle comprising the battery pack according to claim 20.

22: The electric coolant pump according to claim 12, wherein the electric coolant pump is included in a battery-powered motor vehicle to cool battery packs of a drive of the motor vehicle.
